(19) United States
(12) Patent Application Publication
(10) Pub. No.: US 2007/0235142 A1
(43) Pub. Date: Oct. 11, 2007

(54) Laminator

(75) Inventor: Kuang-Hui Chou, Taipei County (TW)

Correspondence Address: BIRCH STEWART KOLASCH & BIRCH, PO BOX 747, FALLS CHURCH, VA, 22040-0747, US

(73) Assignee: TEX YEAR INDUSTRIES INC.

(21) Appl. No.: 11/391,544

(22) Filed: Mar. 29, 2006

(51) Int. Cl. B32B 37/00; B30B 3/04; B30B 15/34

(52) U.S. Cl. 156/555; 156/580; 100/327; 100/176

(57) ABSTRACT

A laminator is disclosed to include two support frame structures each having a bottom bracket, two top brackets, the top brackets each having a first end vertically movably coupled to the top wall of the bottom bracket and a second end pivotally coupled together to a top middle part of the bottom bracket w, and a sheet-transfer roll set, which has a first pair of rolls respectively pivotally mounted on the bottom bracket and one top bracket and a second pair of rolls respectively pivotally mounted on the bottom bracket and the other top bracket.

### BACKGROUND OF THE INVENTION

1. Field of the Invention

The present invention relates to a laminator for laminating all kinds of cards, photos, notes, leaflets, catalogues and any other document and more particularly, to such a laminator, which is stable and durable in use and, which effectively buffers the pressure from the sheet-transfer roll set during laminating operation.

2. Description of the Related Art

Taiwan Patent Application No. 089217361 discloses a laminator. This structure of laminator, as shown in FIG. 1, comprises two support frame structures and a sheet-transfer roll set supported between the two support frame structures. Each support frame structure comprises an upper holder frame 10A, a bottom holder frame 20A that supports the upper holder frame 10A, and a plurality of tensile springs 30A connected between the upper holder frame 10A and the bottom holder frame 20A. When laminating a relatively thicker workpiece, the upper holder frame 10A can be moved upwards to adjust the pitch between the impression rolls 12A and sheet-transfer rolls 22A of the sheet-transfer roll set. This structure of laminator is functional. However, because this structure of laminator uses the tensile springs 30A to control the pitch between the impression rolls 12A and sheet-transfer rolls 22A of the sheet-transfer roll set, the upper holder frame 10A will be tilted in one direction relative to the bottom holder frame 20A to force the rear impression roll 12A against the rear sheet-transfer roll 22A when the workpiece is moved in between the front impression roll 12A and the front sheet-transfer roll 22A. At this time, a great friction resistance will be produced against the driving force of the driving motor. Therefore, the driving motor of this structure of laminator wears quickly. In order to support such a friction resistance, the structural strength and material strength are critical, resulting in a high manufacturing cost.

### SUMMARY OF THE INVENTION

The present invention has been accomplished under the circumstances in view. It is the main object of the present invention to provide a laminator, which is stable and durable in use and effectively buffers the pressure from the sheet-transfer roll set during laminating operation. It is another object of the present invention to provide a laminator, which is durable in use To achieve these and other objects of the present invention, the laminator comprises two support frame structures, two pivot pins, and a sheet-transfer roll set.

The two support frame structures are arranged in parallel, each comprising a bottom bracket, a first top bracket, and a second top bracket. The bottom bracket has a top wall. The first top bracket and the second top bracket each have a front end and a rear end. The front end of the first top bracket is vertically movably coupled to a front side of the top wall of the associating bottom bracket. The rear end of the second top bracket is vertically movably coupled to a rear side of the top wall of the associating bottom bracket. The two pivot pins are respectively inserted through the rear end of the first top bracket of each of the two support frame structures and the front end of the second top bracket of each of the two support frame structures and fastened to the bottom bracket of each of the two support frame structures to respectively pivotally couple the respective first top brackets and second top brackets to the associating bottom brackets. The sheet-transfer roll set is supported between the two support frame structures, comprising a first pair of rolls respectively pivotally mounted on the bottom bracket and first top bracket of each of the two support frame structures and a second pair of rolls respectively pivotally mounted on the bottom bracket and second top bracket of each of the two support frame structures.

### BRIEF DESCRIPTION OF THE DRAWINGS

FIG. 1 is an elevational view of a laminator according to the prior art.

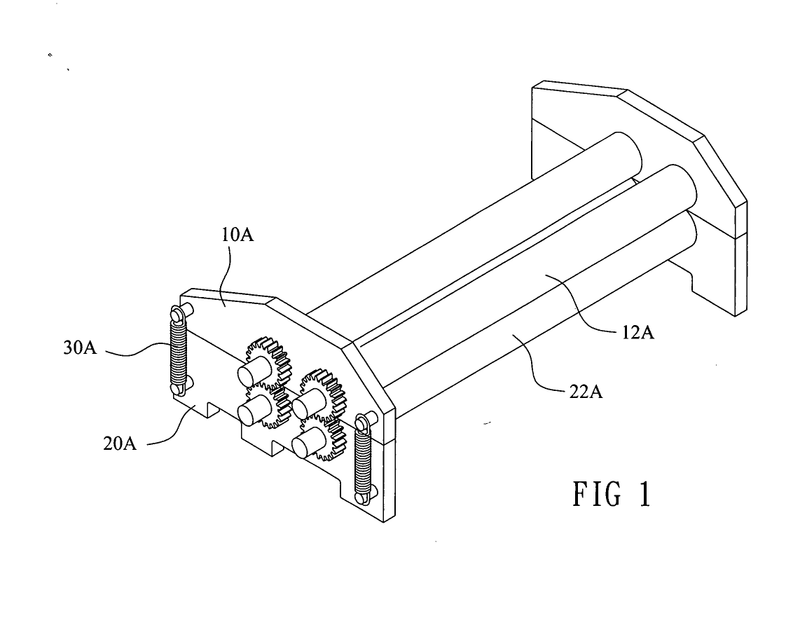

FIG. 2 is a schematic sectional view of the prior art design, showing the laminator in operation.

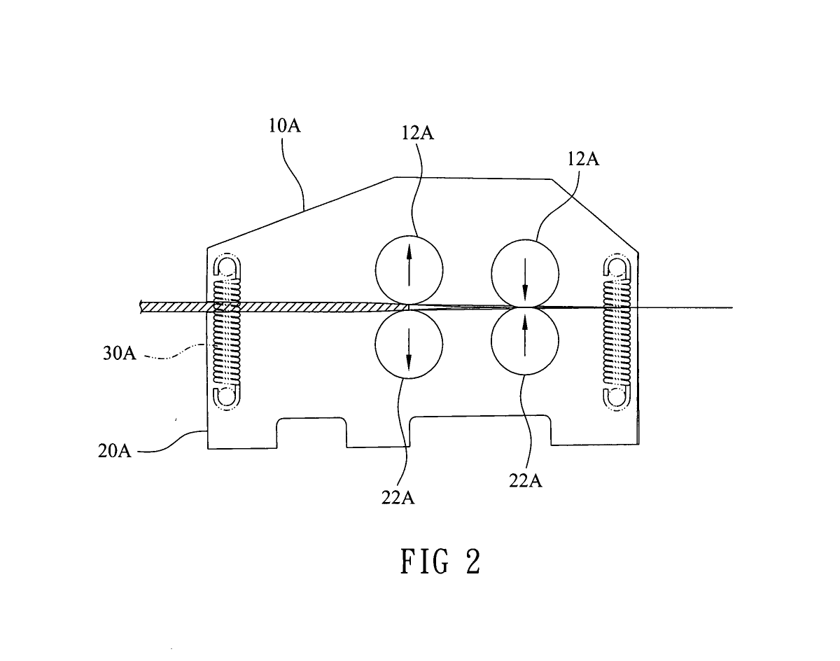

FIG. 3 is a perspective view of a part of a laminator according to the present invention.

FIG. 4 is an exploded view of FIG. 3.

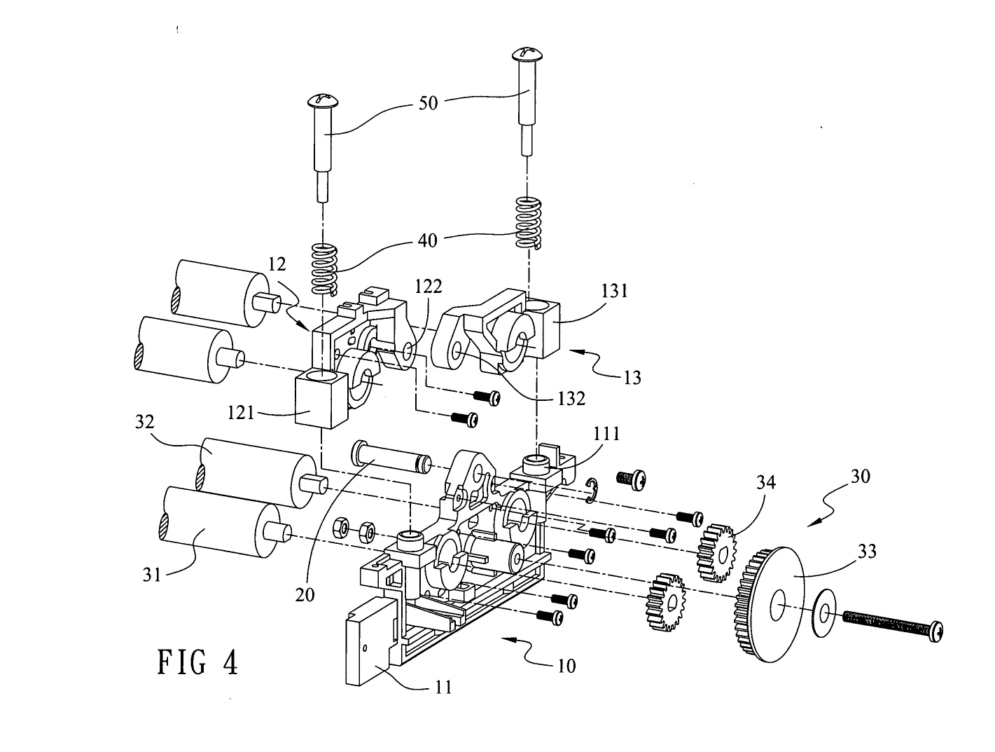

FIG. 5 is a schematic sectional side view of the present invention, showing the laminator in operation.

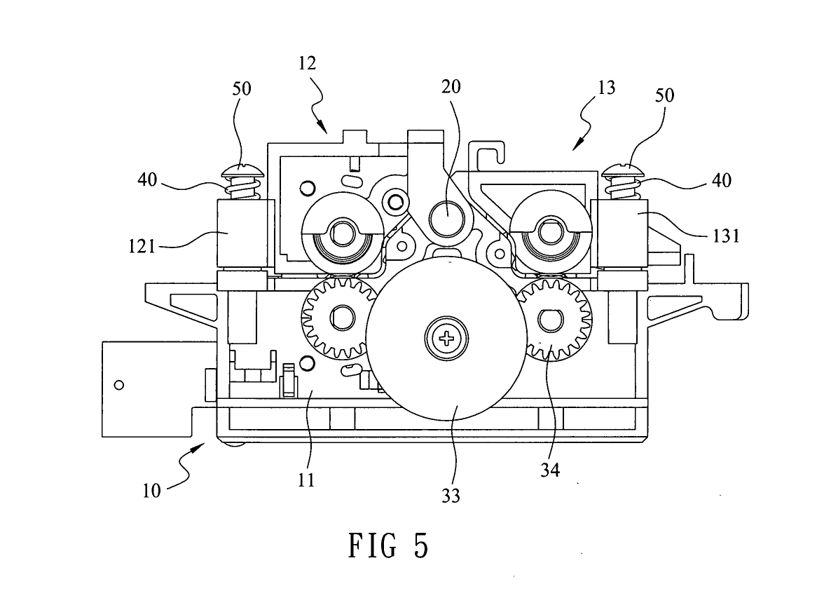

### DETAILED DESCRIPTION OF THE INVENTION

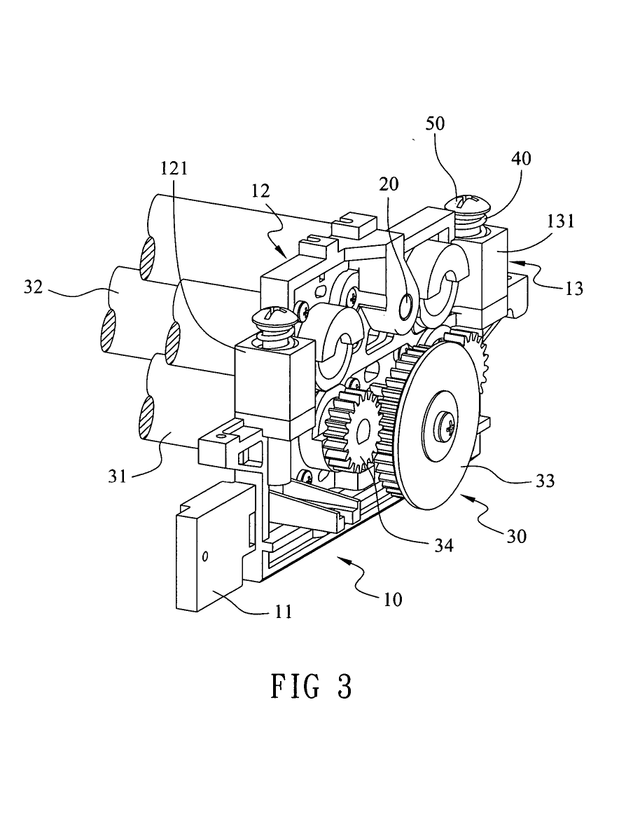

Referring to FIGS. 3˜5, a laminator in accordance with the present invention is shown comprising two support frame structures 10 arranged in parallel. Each support frame structure 10 comprises a bottom bracket 11, a first top bracket 12, and a second top bracket 13. The first top bracket 12 and the second top bracket 13 are respectively coupled to the bottom bracket 11 at the top. The first top bracket 12 is disposed in front of the second top bracket 13. The first top bracket 12 and the second top bracket 13 each have a hollow mounting block 121 or 131 vertically disposed at one end. The bottom bracket 11 has two upright coupling stub tubes 111 respectively upwardly extending from the top wall thereof and respectively inserted into the hollow mounting blocks 121 and 131 of the top brackets 12 and 13. Two mounting screws 50 are respectively inserted through the hollow mounting blocks 121 and 131 of the top brackets 12 and 13 and the upright coupling stub tubes 111 of the bottom bracket 11 and threaded into the top wall of the bottom bracket 11 to secure the top brackets 12 and 13 to the bottom bracket 11, allowing vertical movement of the top brackets 12 and 13 relative to the bottom bracket 11. Further, two spring member, for example, compression springs 40 are respectively mounted on the mounting screws 50 to impart a downward pressure to the top brackets 12 and 13 relative to the bottom bracket 11, allowing vertical movement of the top brackets 12 and 13 relative to the bottom bracket 11 to buffer the laminating pressure during the operation of the laminator.

The top brackets 12 and 13 each further have a horizontal through hole 122 or 132 horizontally disposed at the other end remote from the hollow mounting block 121 or 131. The horizontal through holes 122 and 132 of the top brackets 12 and 13 are coupled to the bottom bracket 11 with a pivot pin 30.

A sheet-transfer roll set 30 is supported on the two support frame structures 10. The sheet-transfer roll set 30 comprises a first pair of rolls 31 respectively mounted on the bottom bracket 11 and the first top bracket 12, and a second pair of rolls 32 respectively mounted on the bottom bracket 11 and the second top bracket 13, a drive gear wheel 33 pivotally mounted on the bottom bracket 11 of one support frame structure 10, and two transmission gears 34 respectively mounted on the rolls 31 and 32 at the bottom bracket 11 of the associating support frame structure 10 and meshed with the drive gear wheel 33 (the first pair of rolls 31 and the second pair of rolls 32 each include a sheet-transfer roll and an impression roll). Rotating the drive gear wheel 33 cause the transmission gears 34 to rotate the rolls 31 and 32, thereby transferring the workpiece with the laminating films from the input side (not shown) of the laminator to the output side (not shown) of the laminator.

Referring to FIGS. 3˜5 again, the first top bracket 12 and second top bracket 13 of each support frame structure 10 are respectively movably coupled to the associating bottom bracket 11 to support the sheet-transfer roll set 30 in a flexible manner. The pivot pin 30 is inserted through the top brackets 12 and 13 and a top middle part of the bottom bracket 11 to secure one end of each of the top brackets 12 and 13 together. Because the top brackets 12 and 13 each have one end pivotally coupled to the pivot pin 20 on the top middle part of the bottom bracket 11 and the other end respectively coupled to the two upright coupling stub tubes 111 at two distal ends of the top wall of the bottom bracket 11, the spring members 40 and the mounting screws 50 can hold down the top brackets 12 and 13 on the bottom bracket 11 without much pressure. Therefore, the bottom bracket 11 does not receive much pressure from the spring members 40 during laminating operation of the laminator. Further, because the top brackets 12 and 13 are movably coupled to the bottom bracket 11 and held down by the spring members 40 and because the rolls 31 and 32 are respectively supported on the top brackets 12 and 13 and the bottom bracket 11, the rolls 31 and 32 of the sheet-transfer roll set 30 do not receive much pressure from the workpiece during laminating operation of the laminator. Therefore, the motor of the driving mechanism (not shown) of the laminator does not receive much resisting force from the sheet-transfer roll set 30 during operation. In general, the design of the present invention greatly prolongs the working life of the laminator, and assures smooth laminating operation.

A prototype of laminator has been constructed with the features of FIGS. 3˜5. The laminator functions smoothly to provide all of the features discussed earlier

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A laminator comprising:
two support frame structures arranged in parallel, said support frame structures each comprising a bottom bracket, a first top bracket, and a second top bracket, said bottom bracket having a top wall, said first top bracket and said second top bracket each having a front end and a rear end, the front end of said first top bracket being vertically movably coupled to a front side of the top wall of the associating bottom bracket, the rear end of said second top bracket being vertically movably coupled to a rear side of the top wall of the associating bottom bracket;
two pivot pins respectively inserted through the rear end of the first top bracket of each of said two support frame structures and the front end of the second top bracket of each of said two support frame structures and fastened to the bottom bracket of each of said two support frame structures to respectively pivotally couple the respective first top brackets and second top brackets to the associating bottom brackets; and
a sheet-transfer roll set supported between said support frame structures, said sheet-transfer roll set comprising a first pair of rolls respectively pivotally mounted on the bottom bracket and first top bracket of each of said two support frame structures and a second pair of rolls respectively pivotally mounted on the bottom bracket and second top bracket of each of said two support frame structures.

2. The laminator as claimed in claim 1, wherein the bottom bracket of each of said two support frame structures has two upright coupling stub tubes respectively upwardly extending from the top wall thereof near; the front end of the first top bracket and the rear end of the second top bracket of each of said two support frame structures each have a hollow mounting block respectively sleeved onto the upright coupling stub tubes of the associating bottom bracket and secured thereto with a respective mounting screw and a respective spring member, said spring member being adapted to impart a downward pressure to the associating hollow mounting block relative to the associating bottom bracket.

3. The laminator as claimed in claim 1, wherein said sheet-transfer roll set further comprises a drive gear wheel pivotally mounted on the bottom bracket of one of said two support frame structures, and two transmission gears respectively mounted on the rolls of said sheet-transfer roll set that are supported on the bottom bracket of each of said two support frame structures and meshed with said transmission gear wheel.

4. The laminator as claimed in claim 1, wherein the bottom brackets of said two support frame structures each have a through hole for the mounting of said pivot pins.
